(19) United States
(12) Patent Application Publication
(10) Pub. No.: US 2009/0135605 A1
(43) Pub. Date: May 28, 2009

(54) LED UNIT

(75) Inventors: FANG-WEI XU, Shenzhen (CN); GUANG YU, Shenzhen (CN); CHENG-TIEN LAI, Tu-Cheng (TW)

Correspondence Address: PCE INDUSTRY, INC.;ATT. Steven Reiss, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/024,958

(22) Filed: Feb. 1, 2008

(30) Foreign Application Priority Data
Nov. 23, 2007 (CN) 200710124673.8

(51) Int. Cl. F21V 7/00

(52) U.S. Cl. 362/304; 362/310

(57) ABSTRACT

An LED unit (10) includes an LED (20) and a lens (30) disposed on the LED. The lens includes a square body (32) and a frustum-shaped body (34) formed downwardly from the square body, wherein a tapered side face (342) of the frustum-shaped body is coated with a reflective film. The LED includes a lens (26) that has a planar top face (28) directly contacting with a planar, circular bottom face (340) of the frustum-shaped body of the lens; thus light emitted from an LED chip (23) in the LED can pass through the lens of the LED and the lens without a total internal reflection occurring at an interface between the lens of the LED and the lens. Accordingly, a high bright light is obtained since nearly all of the light can be transmitted out of the LED unit.

### BACKGROUND OF THE INVENTION

1. Field of the Invention

The present invention relates to an LED unit, and more particularly to an LED unit having an optimized lens for improving a light emission from an LED.

2. Description of Related Art

A typical LED often emits its light energy in a nearly hemispherical beam pattern. So most LED applications require substantial modification of this output beam profile to provide useful energy. Conventionally, a method for achieving this is to use reflectors, lens, and a combination of these.

US patent publication No. 2002/0093820 A1 discloses an LED lamp, which comprises a heat sink housing, an array of LEDs arranged in the heat sink housing, a reflector positioned over the LEDs, and a lens connecting with the heat sink housing and covering the reflector and LEDs. Each of the LEDs comprises an LED chip and an enclosure packing the LED chip for fixing and protecting the LED chip. When the LEDs are activated, the light emitted from the LED chips is reflected by the reflector to concentrate in respective beams, which converge into an integral beam after passing through the lens. Therefore, most light emitted from the LEDs is able to be conveyed to the ambient, and a high bright light is thus obtained.

However, there is a big problem in said LED lamp: the enclosure is often made from a transparent material such as epoxy or silicone, which has a refractive index larger than that of air. That means when the light is conveyed from the enclosure to the air that is received between the enclosure of the LED and the lens of the LED lamp, a total internal reflection may occur at the interface between the air and the enclosure. A part of light will be reflected back to the inner of the LED and cannot emit through the lens of the LED lamp, which causes the brightness of the light to be lowered.

What is needed, therefore, is an LED unit which can overcome the above-mentioned disadvantages.

### SUMMARY OF THE INVENTION

An LED unit includes an LED and a lens disposed on the LED. The lens includes a square body and a frustum-shaped body formed downwardly from the square body, wherein a tapered side face of the frustum-shaped body is coated with a reflective film. The LED includes a lens that has a planar top face directly contacting with a planar, circular bottom face of the frustum-shaped body of the lens, thus light emitted from an LED chip in the LED can pass through the lens of the LED and the lens without a total internal reflection occurring at an interface between the lens of the LED and the lens. Accordingly, a high bright light is obtained since nearly all of the light generated by the LED chip can be transmitted out of the LED unit via the lens of the LED and the lens, which are intimated contacted with each other.

Other advantages and novel features of the present invention will become more apparent from the following detailed description when taken in conjunction with the accompanying drawings, in which:

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled, isometric view of an LED unit in accordance with a preferred embodiment of the present invention;

FIG. 2 is an exploded view of FIG. 1;

FIG. 3 is an inverted view of a lens of the LED unit of FIG. 2; and

FIG. 4 is a cross-sectional view taken along line IV-IV of FIG. 1.

### DETAILED DESCRIPTION OF THE INVENTION

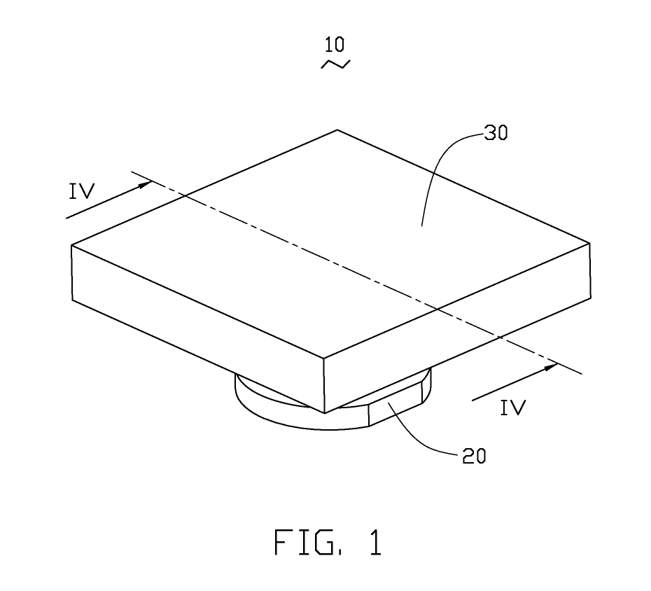

Referring to FIG. 1, an LED unit 10 in accordance with a preferred embodiment of the present invention comprises an LED 20 and a lens 30 attached on the LED 20 for improving a light emission of the LED 20.

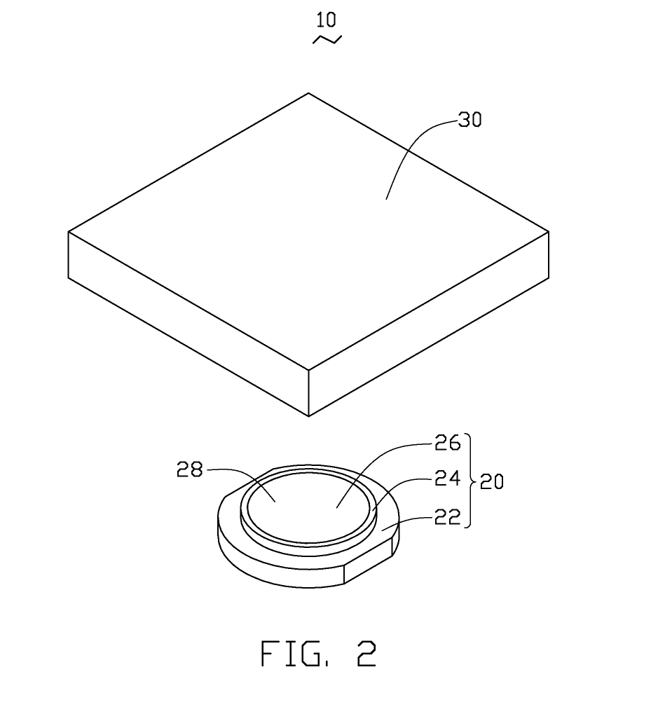

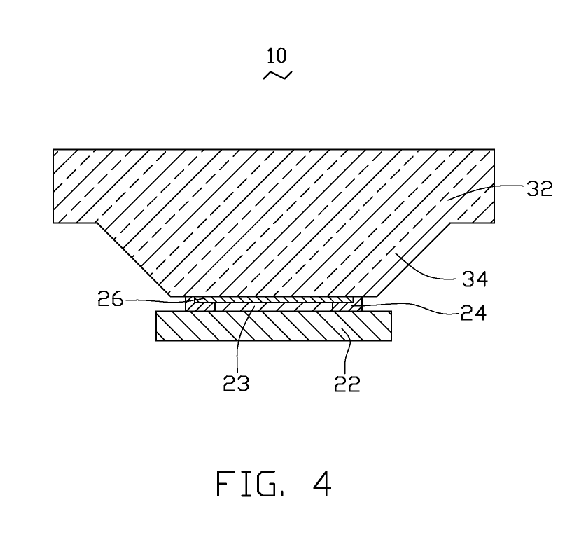

As shown in FIGS. 2 and 4, the LED 20 comprises a base 22, an LED chip 23 disposed on the base 22, a sidewall 24 extending upwardly and perpendicularly from the base 22 and surrounding the LED chip 23, and a lens 26 enclosed by the sidewall 24 and covering the LED chip 23. The base 22 has a circular shape with two opposite straight sides for facilitating fitting of the base 22 into a corresponding hole defined in a substrate (not shown), and the sidewall 24 has an annular configuration that is coaxial with the base 22. The lens 26 is a circular plate, and has a top face (not labeled) being coplanar with that of the sidewall 24, whereby the lens 26 and the sidewall 24 cooperatively define a planar top face 28 for the LED 20.

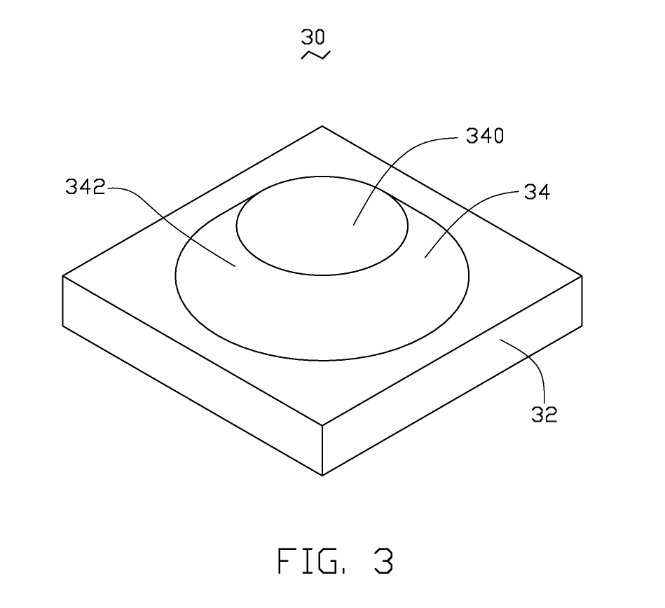

Referring to FIGS. 2-4, the lens 30 mounted on the LED 20 has a thickness larger than that of the lens 26 of the LED 20. The lens 30 is made of a transparent material such as epoxy, silicone, glass and so on, which is identical to the material of the lens 26 of the LED 20. The lens 30 comprises a square body 32 and a frustum-shaped body 34 extending coaxially and downwardly from the square body 32, wherein a bottom face (not labeled) of the square body 32 has an area larger than a top face (not labeled) of the frustum-shaped body 34 which connects with the bottom face of the square body 32. A diameter of the frustum-shaped body 34 decreases downwardly in a manner that a tapered face 342 is defined at a side periphery of the frustum-shaped body 34, and a planar, circular face 340 is defined at a bottom of the frustum-shaped body 34. The planar, circular bottom face 340 directly contacts the planar top face 28 of the LED 20, thereby realizing an intimate contact between the lens 26 of the LED 20 and the lens 30. The tapered face 342 of the frustum-shaped body 34 is coated with a reflective film (not shown) thereon, thus enabling the frustum-shaped body 34 to function as a reflector which can reflect light produced by the LED chip 23 of the LED 20 when the light enters the lens 30.

Since the lens 30 and the lens 26 of the LED 20 are made of the same material, difference of reflective index therebetween is eliminated; moreover, the direct contact between the top face 28 of the LED 20 and the planar, circular bottom face 340 of the lens 30 can prevent air from existing therebetween, whereby a light pathway having a uniform reflective index is formed in the lens 30 and the lens 26 of the LED 20. When the LED chip 23 is activated, nearly all of the light emitted by the LED chip 23 can travel through the lens 26 of the LED 20 and the lens 30 via the light pathway, without a total internal reflection occurring at an interface between the lens 30 and the lens 26. On the other hand, the light that has traveled through the interface is reflected by the reflective film of the frustum-shaped body 34, and then concentrated into a straight beam. The straight beam extends through the square body 32 of the lens 30 and is conveyed to an outside of the lens 30, thereby to irradiate ambient objects. Therefore, loss of the light during the transmission process through the LED unit 10 can be minimized, and a high bright light is obtained accordingly.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED assembly comprising:
an LED; and
a lens disposed on the LED, the lens comprising:
a first body directly contacting the LED, a reflective film being formed around the first body; and
a second body formed on the first body, wherein when LED is activated, light emitted from the LED travels through the lens without a total internal reflection occurring at an interface between the LED and the lens.

2. The LED assembly as claimed in claim 1, wherein the second body has a square configuration and has a bottom face connecting with a top surface of the first body of the lens, an area of the bottom face of the second body being larger than that of the top surface of the first body.

3. The LED assembly as claimed in claim 1, wherein the first body of the lens has a frustum-shaped configuration and defines a planar bottom surface contacting with the LED.

4. The LED assembly as claimed in claim 3, wherein a cross section of the first body of the lens is a circle.

5. The LED assembly as claimed in claim 3, wherein a diameter of the first body of the lens decreases downwardly.

6. The LED assembly as claimed in claim 3, wherein the first body of the lens defines a tapered side surface, which is coated with the reflective film.

7. The LED assembly as claimed in claim 2, wherein the LED comprises a base, an LED chip disposed on the base, a sidewall extending upwardly from the base and surrounding the LED chip, and an additional lens enclosed by the sidewall and covering the LED chip, the additional lens of the LED contacting the planar bottom surface of the first body of the lens.

8. The LED assembly as claimed in claim 7, wherein a top face of the additional lens is coplanar with a top face of the sidewall of the LED, the top face of the additional lens and the top face of the sidewall of the LED cooperatively defining a planar top face of the LED to directly contact the bottom surface of the first body of the lens.

9. The LED assembly as claimed in claim 7, wherein the first body is coaxial with the second body of the lens and the additional lens of the LED.

10. The LED assembly as claimed in claim 7, wherein the additional lens of the LED and the lens are made of the same material.

11. An LED unit comprising:
an LED comprising a lens having a planar top face;
another lens mounted on the LED, comprising:
a square member; and
a frustum-shaped member extending downwardly from the square member, the frustum-shaped member having a planar bottom face directly contacting with the planar top face of the lens of the LED, thereby preventing a total internal reflection from occurring at an interface between the another lens and the lens of the LED.

12. The LED unit as claimed in claim 11, wherein the frustum-shaped member of the another lens is located at a central area of the square member and has a downwardly decreasing diameter.

13. The LED unit as claimed in claim 11, wherein a side face of the frustum-shaped member of the another lens is coated with a reflective film for converging light from the LED.

14. The LED unit as claimed in claim 11, wherein the lens of the LED is coaxial with the another lens.

15. The LED unit as claimed in claim 11, wherein a thickness of the another lens is larger than that of the lens of the LED.

16. The LED unit as claimed in claim 11, wherein the another lens and the lens of the LED are made of transparent material with the same reflective index.

17. An LED unit comprising:
an LED having an LED chip for generating light;
a lens mounted on the LED for guiding light generated by the LED chip to be transmitted along a predetermined direction, wherein the lens has a frustum-shaped portion intimately contacting with the LED, the frustum-shaped portion being attached with a reflective film on a side periphery thereof.

18. The LED unit as claimed in claim 17, wherein the lens further comprises a rectangular portion connecting with the frustum-shaped portion and distant from the LED.

19. The LED unit as claimed in claim 18, wherein the lens is made of transparent material.

20. The LED unit as claimed in claim 19, wherein the lens is made of one of epoxy, silicone and glass.
